(19) United States
(12) Patent Application Publication
(10) Pub. No.: US 2010/0142094 A1
(43) Pub. Date: Jun. 10, 2010

(54) MAGNETIC HEAD SLIDER AND MAGNETIC DISK DEVICE

(75) Inventors: Tohru FUJIMAKI, Yokohama-shi (JP); Takahiro IMAMURA, Ome-shi (JP); Toru WATANABE, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/692,485

(22) Filed: Jan. 22, 2010

Related U.S. Application Data
(63) Continuation of application No. PCT/JP2007/064587, filed on Jul. 25, 2007.

(51) Int. Cl. G11B 5/60

(52) U.S. Cl. 360/235.4; G9B/5.229

(57) ABSTRACT

According to one embodiment, a magnetic head slider includes: a magnetic head; a slider main body configured to be provided with the magnetic head; a first protrusion portion configured to be provided on the slider main body so as to abut the magnetic head; a second protrusion portion configured to be provided on a top surface of the first protrusion portion; and a cutout portion configured to be provided to an edge portion on the top surface of the second protrusion portion, the edge portion being on a side of the top surface.

### CROSS-REFERENCE TO RELATED APPLICATIONS

This application is a continuation of PCT international application Ser. No. PCT/JP2007/064587 filed on Jul. 25, 2007 which designates the United States, incorporated herein by reference.

### BACKGROUND

1. Field

One embodiment of the invention relates to a magnetic head slider, and especially to a magnetic head slider for improving recording density by narrowing a gap between a magnetic head and a magnetic disk when being applied to a magnetic disk device.

2. Description of the Related Art

In recent years, as the recording density of magnetic disk devices increases, a flying gap (so-called “head flying height”) between a magnetic head mounted on a magnetic head slider and a magnetic disk tends to be narrow. Recently, there is used a mechanism in which a heater or the like is used near the magnetic head provided on the slider to deform the magnetic head so that the magnetic head protrudes. A magnetic disk device including a magnetic head which uses the protruding mechanism can perform reading/writing to a recording medium with high density. For example, Japanese Patent Application Publication (KOKAI) No. 2004-259351 discloses a magnetic head, and discloses that: a heater is mounted near the magnetic head; electric power is supplied to the heater; the magnetic head module is protruded; and a gap between the magnetic head and a disk is narrowed, in order to decrease the flying height of the magnetic head.

As the density of hard disks increases, the head flying height tends to decrease year by year. In recent years, a head flying height of about 10 nm is required. When protruding the magnetic head module to decrease the head flying height, a force such as an intermolecular force acts between an area near the magnetic head and the magnetic disk, and the magnetic head slider may generate unstable vibration.

One of unstable vibration modes is a pitching mode in which a vibration node is near the gravity center of the magnetic head slider. In the pitching mode, vibration is easily occurred when the protrusion of the magnetic head is large. Therefore, when an amount of protrusion of the magnetic head is increased to decrease the head flying height, there is a risk that a failure occurs in a recording/reproducing function of the magnetic disk device, or the magnetic disk and the magnetic head are damaged.

### BRIEF DESCRIPTION OF THE SEVERAL VIEWS OF THE DRAWINGS

A general construction that implements the various features of the invention will now be described with reference to the drawings. The drawings and the associated descriptions are provided to illustrate embodiments of the invention and not to limit the scope of the invention.

FIG. 1 is an exemplary cross sectional view of a magnetic disk device using a magnetic head slider according to one embodiment of the invention;

FIG. 2 is an exemplary plan view of the magnetic head slider in the embodiment;

FIG. 3A is an exemplary partial enlarged view of the magnetic head slider of FIG. 2;

FIG. 3B is an exemplary cross sectional view of the P-Q cross section of FIG. 3A;

FIG. 3C is an exemplary cross sectional view of the R-S cross section of FIG. 3A;

FIG. 4 is an exemplary cross sectional view of the R-S cross section in FIG. 2;

FIG. 5 is an exemplary enlarged perspective view of a portion A in the magnetic head slider in FIG. 2;

FIG. 6 is an exemplary contour map of a surface protrusion, which faces a recording medium, of the magnetic head and its neighboring areas when the magnetic head is heated by a heater in the embodiment;

FIG. 7 is an exemplary cross sectional view illustrating a behavior of pitching vibration having a vibration node near the gravity center of the magnetic head slider in the embodiment;

FIG. 8A is an exemplary partial enlarged view illustrating an air flow at a center island and its neighboring areas on the surface of the magnetic head slider inside the magnetic disk device including the magnetic head slider of FIG. 2;

FIG. 8B is an exemplary cross sectional view of the P-Q cross section in FIG. 8A;

FIG. 9A is an exemplary partial enlarged view of a magnetic head slider according to another embodiment of the invention;

FIG. 9B is an exemplary cross sectional view of the P-Q cross section in FIG. 9A;

FIG. 10A is an exemplary partial enlarged view of a magnetic head slider according to still another embodiment of the invention;

FIG. 10B is an exemplary cross sectional view of the P-Q cross section in FIG. 10A;

FIG. 11A is an exemplary partial enlarged view of a magnetic head slider according to still another embodiment of the invention;

FIG. 11B is an exemplary cross sectional view of the P-Q cross section in FIG. 11A;

FIG. 12A is an exemplary partial enlarged view of a magnetic head slider according to still another embodiment of the invention;

FIG. 12B is an exemplary cross sectional view of the P-Q cross section in FIG. 12A;

FIG. 13A is an exemplary partial enlarged view of a magnetic head slider according to still another embodiment of the invention;

FIG. 13B is an exemplary cross sectional view of the P2-Q2 cross section in FIG. 13A;

FIG. 13C is an exemplary cross sectional view of the P1-Q2 cross section in FIG. 13A in the embodiment;

FIG. 14A is an exemplary partial enlarged view of a magnetic head slider according to still another embodiment of the invention;

FIG. 14B is an exemplary cross sectional view of the P-Q cross section in FIG. 14A;

FIG. 15A is an exemplary partial enlarged view of a magnetic head slider according to still another embodiment of the invention;

FIG. 15B is an exemplary cross sectional view of the P-Q cross section in FIG. 15A;

FIG. 15C is an exemplary cross sectional view of the R-S cross section in FIG. 15A;

FIG. 16A is an exemplary partial enlarged view of a magnetic head slider according to still another embodiment of the invention;

FIG. 16B is an exemplary cross sectional view of the P-Q cross section in FIG. 16A;

FIG. 17A is an exemplary partial enlarged view of a magnetic head slider according to still another embodiment of the invention;

FIG. 17B is an exemplary cross sectional view of the R-S cross section in FIG. 17A;

FIGS. 18A to 18D are exemplary diagrams illustrating a result of analyzing a relation between a protrusion amount and a head flying height when an area near the magnetic head is gradually protruded in a magnetic disk device including the magnetic head slider according to a first to a fourth examples, respectively, of the invention;

FIG. 18E is an exemplary diagram illustrating a result of analyzing a relation between a protrusion amount and a head flying height when an area near the magnetic head is gradually protruded in a magnetic disk device including the magnetic head slider according to a comparison example of the invention;

FIGS. 19A to 19C are exemplary diagrams illustrating the transfer function of the impulse response of the magnetic head slider in the first to the third examples in the embodiment;

FIG. 19D is an exemplary diagram illustrating the transfer function of the impulse response of the magnetic head slider in the comparison example;

FIG. 20 is an exemplary plan view of the magnetic head slider in the second example;

FIG. 21 is an exemplary plan view of the magnetic head slider in the third and the fourth example;

FIG. 22 is an exemplary plan view of the magnetic head slider in the comparison example;

FIG. 23A is an exemplary partial enlarged view of the magnetic head slider of FIG. 21; and

FIG. 23B is an exemplary cross sectional view of the P-Q cross section of FIG. 21.

### DETAILED DESCRIPTION

Various embodiments according to the invention will be described hereinafter with reference to the accompanying drawings. In general, according to one embodiment of the invention, a magnetic head slider includes: a magnetic head; a slider main body configured to be provided with the magnetic head; a first protrusion portion configured to be provided on the slider main body so as to abut the magnetic head; a second protrusion portion configured to be provided on a top surface of the first protrusion portion; and a cutout portion configured to be provided to an edge portion on the top surface of the second protrusion portion, the edge portion being on a side of the top surface.

According to another embodiment of the invention, a magnetic disk device includes a recording medium and a magnetic head slider arranged so as to face the recording medium. The magnetic disk device includes: a magnetic head slider. The magnetic head slider comprises: a magnetic head; a base portion configured to be provided with the magnetic head; a first protrusion portion configured to be provided on the base portion so as to abut the magnetic head; a second protrusion portion configured to be provided on a top surface of the first protrusion portion opposed to the recording medium; and a cutout portion configured to be provided to an edge portion on the top surface of the second protrusion portion opposed to the recording medium, the edge portion being on a side of the top surface.

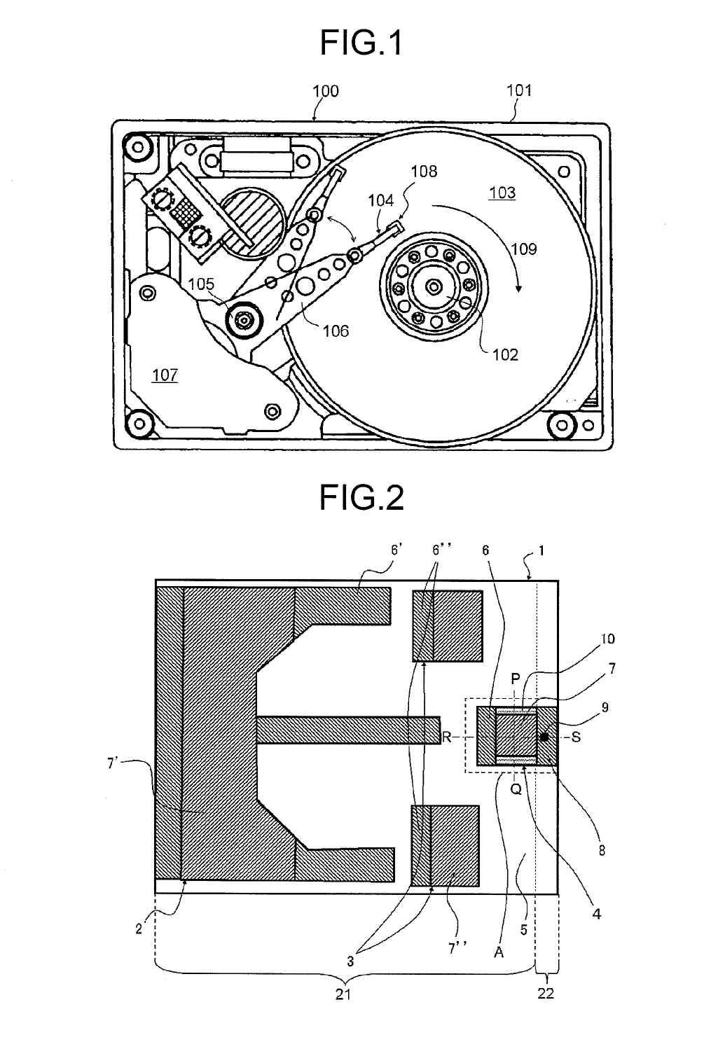

First, a magnetic disk device utilizing a magnetic head slider according to one embodiment of the invention will be briefly described with reference to FIG. 1. FIG. 1 is a schematic cross sectional view illustrating the magnetic disk device (hard disk drive: HDD) using the magnetic head slider. In FIG. 1, a HDD 100 comprises a housing 101. A magnetic disk 103 mounted on a spindle motor 102 and a head gimbal assembly 104, on which a magnetic head slider 108 is mounted, facing the magnetic disk 103 are arranged in the housing 101. The head gimbal assembly 104 including the magnetic head slider 108 is fixed to the top end of a carriage arm 106 swingably around a shaft 105. The carriage arm 106 is swingably driven by an actuator 107, and the magnetic head slider 108 is positioned to a desired recording track on the magnetic disk (recording medium) 103. By doing so, the magnetic head slider 108 can write information to the magnetic disk 103 or read information from the magnetic disk 103.

Next, the magnetic head slider of the embodiment will be described.

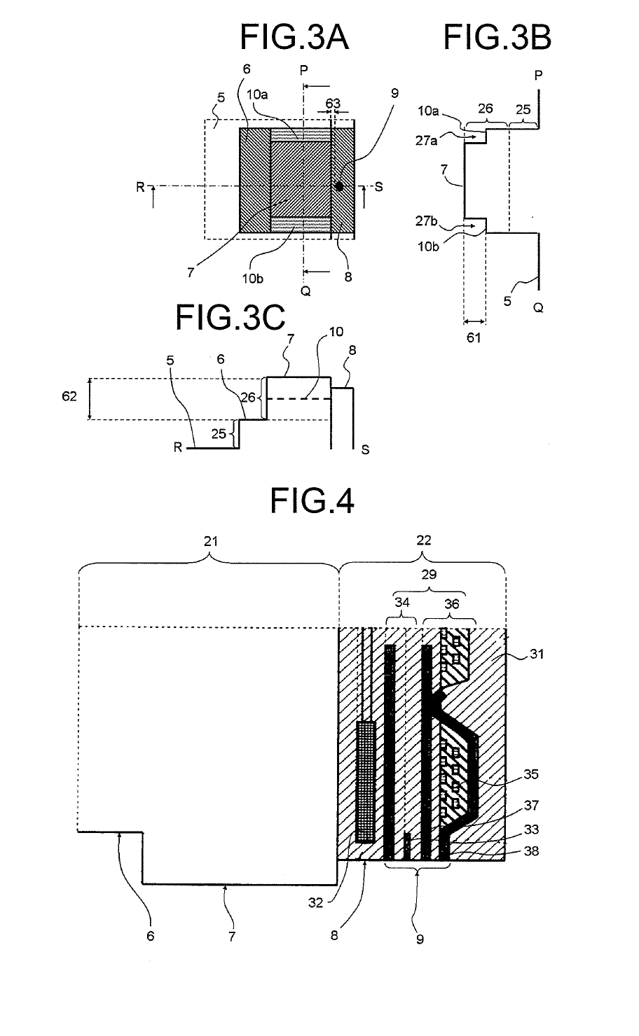

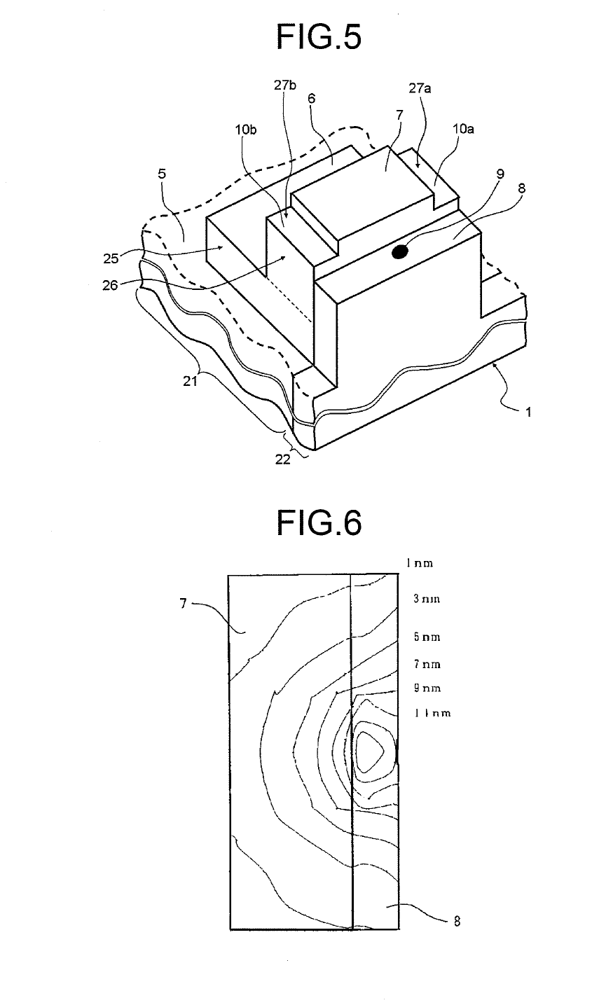

FIG. 2 is a schematic plan view illustrating the magnetic head slider of the embodiment, and the schematic plan view illustrates a surface that faces the recording medium in the magnetic disk device when the magnetic head slider is used in the magnetic disk device. FIG. 3A is a partial enlarged view of a portion A of the magnetic head slider in FIG. 2. FIG. 3B is a cross sectional view of the P-Q cross section in FIG. 3A. FIG. 3C is a cross sectional view of the R-S cross section in FIG. 3A. FIG. 4 is a cross sectional schematic view illustrating the R-S cross section of the magnetic head slider in FIG. 2. FIG. 5 is an enlarged perspective view of the portion A of the magnetic head slider in FIG. 2.

As illustrated in FIGS. 2 to 5, the magnetic head slider comprises a magnetic head 22, a slider main body 21 configured to be provided with the magnetic head 22, a first protrusion portion 25 configured to be provided on the slider main body 21 so that the first protrusion portion 25 abuts the magnetic head 22, a second protrusion portion 26 configured to be provided on an upper surface of the first protrusion portion 25 and opposed to the recording medium 103, and cutout portions each of which is configured to be provided to each of edge portions on an upper surface of the second protrusion portion 26. The edge portions are on two sides of the upper surface as seen from the magnetic head, respectively.

First, the magnetic head 22 will be described. The magnetic head of the embodiment comprises at least a magnetic head element. The magnetic head module may comprise a non-magnetic, non-conductive material layer such as Alumina arranged around the magnetic head element.

The magnetic head element is provided for recording or reproducing information to or from the recording medium in the magnetic disk device. The magnetic head element comprises a recording element having a function to write information to a recording medium, and a reproducing element such as, for example, a magnetoresistance (MR) effect element having a function to retrieve magnetic information recorded in a recording medium as an electric signal. The magnetic head element of the embodiment may comprise either one of the recording element and the reproducing element.

The magnetic head slider illustrated in FIG. 4 comprises a recording head module 36 including a write coil 35, a main magnetic pole layer 37, and an auxiliary magnetic pole layer 38, as the recording element. The write coil 35 has a function to generate a magnetic flux. The main magnetic pole layer 37 has a function to accommodate the magnetic flux generated from the write coil 35 and emit the magnetic flux to the magnetic disk (not depicted in FIG. 4). The auxiliary magnetic pole layer 38 has a function to circulate the magnetic flux emitted from the main magnetic pole layer 37 via the magnetic disk (not depicted in FIG. 4).

Also, the magnetic head slider illustrated in FIG. 4 comprises a reproducing head module 34 including an MR element 33, as the reproducing element. The recording head module 36 and the reproducing head module 34 may be referred to collectively as “head module 29”.

The area surrounding the head module 29 is covered with an alumina layer 31 having non-magnetism and non-conductivity. A heater 32 constituted by Cu, NiFe, and the like is provided near the head module 29 for heating the head module 29. Since the structure of the magnetic head has a normal configuration, a detailed description is omitted.

The magnetic head 22 has a recess surface 8 facing the recording medium in the magnetic disk device. The recess surface 8 comprises a surface 9 (hereinafter may be called “head surface 9”) of the head module 29, the surface 9 facing the recording medium. The recess surface 8 forms a surface level difference from a first air bearing surface (ABS) 7 described below. In the embodiment, although a height relation between the recess surface 8 and the first ABS 7 is not particularly limited, the recess surface 8 is normally 1 nm to 3 nm lower than the ABS at normal temperature.

By heating the heater 32 while the magnetic disk device is running, the surface of the head module 29 facing the recording medium and areas near the surface protrude toward the recording medium due to thermal expansion. The head flying height can be controlled by the protrusion amount. FIG. 6 is a contour map illustrating an example of a surface protrusion of the head module 29 and its neighboring areas when the head module 29 is heated by the heater 32, the surface protrusion facing the recording medium. In FIG. 6, for convenience of description, the first ABS 7 and the recess surface 8 are assumed to have the same height at normal temperature. The protrusion amount is largest at the head module 29, and decreases as it gets farther from the head module 29. Currently, the protrusion amount is at most about 20 nm. Therefore, the recess surface 8 may be higher than the first ABS 7.

Next, the slider main body 21 will be described. As illustrated in FIG. 5, the slider main body 21 comprises the first protrusion portion 25 configured to be provided on the slider main body 21 so that the first protrusion portion 25 s to the magnetic head 22, the second protrusion portion 26 configured to be provided on the upper surface of the first protrusion portion 25 and opposed to the recording medium 103, and cutout portions 27a, 27b configured to be provided to both edge portions of the upper surface of the second protrusion portion 26. The both edge portions are on both sides of the upper surface, respectively, as seen from the magnetic head 22. The first protrusion portion 25 and the second protrusion portion 26 protrude from a deep groove 5. Hereinafter, the cutout portions such as 27a, 27b may be referred to collectively as “cutout portion 27”.

The second protrusion portion 26 abuts the magnetic head 22, and the first protrusion portion 25 is exposed to a side of the second protrusion portion 26 opposite to the surface on which the second protrusion portion 26 and the magnetic head 22 abut with each other. In other words, the upper surface of the first protrusion portion 25 has a first step surface 6 on the opposite side of the surface on which the second protrusion portion 26 and the magnetic head 22 abut with each other.

The upper surface of the second protrusion portion 26 comprises the first ABS 7 which is the highest and bottom portions of the cutout portions 27a, 27b. Hereinafter, the bottom portions of the cutout portions 27a, 27b may be called “second step surfaces 10a, 10b” respectively. Also, hereinafter, the second step surfaces such as 10a, 10b may be referred to collectively as “second step surface 10”.

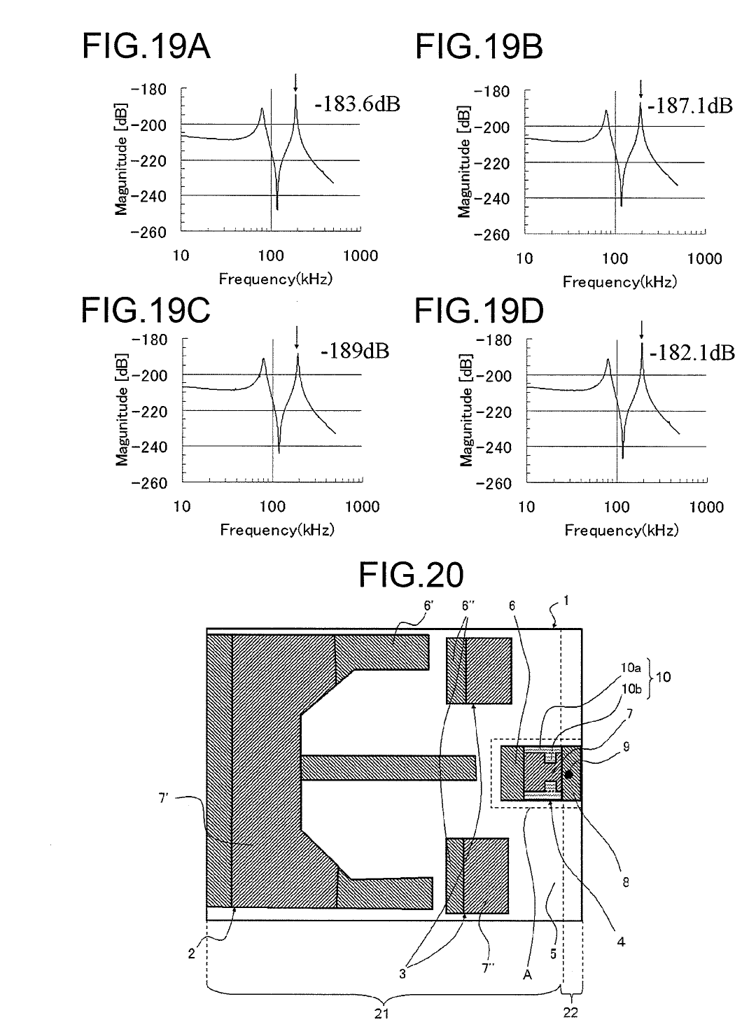

Hereinafter, a portion including the first ABS 7, the second step surface 10, and the first step surface 6 may be collectively called “center island 4”. The center island 4 is normally located in the center facing the air inflow direction of the magnetic head slider 1. The air inflow direction is a direction in which air flows between the magnetic head slider and the magnetic recording medium in the magnetic recording apparatus. In FIG. 2, the air normally flows from left to right. The flow direction is the same as a clockwise rotation direction 109 in the magnetic disk 103 of FIG. 1. The air flow direction is the same in FIGS. 19A to 21 described below.

The slider main body 21 can further comprise the other islands such as a front rail 2 and a side rail 3 which are separated from the center island 4 by the deep groove 5. The front rail 2 and the side rail 3 respectively comprise at least a second ABS 7′ and at least a third ABS 7″. The front rail 2 comprises a third step surface 6′ lower than the second ABS 7′. The side rail 3 comprises a fourth step surface 6″ lower than the third ABS. In the magnetic head slider of the invention, the position, the shape, and the size of the front rail and the side rail are not particularly limited.

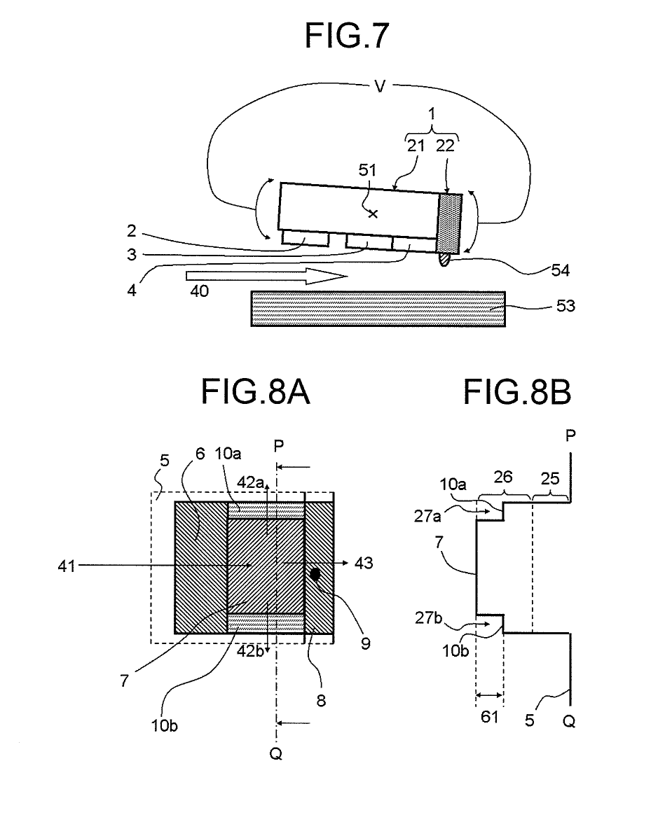

When a conventional magnetic head slider is used in a magnetic disk device, if the magnetic head module is protruded, a pitching vibration having a vibration node near the gravity center of the magnetic head slider is generated. FIG. 7 is a cross sectional schematic view illustrating a behavior of the pitching vibration having a vibration node near the gravity center of the magnetic head slider. When the magnetic disk is running, the magnetic head slider 1 flies in a inclined state with the magnetic head 22 side getting close to a magnetic disk 53, by an air flow 40 generated by the rotation of the magnetic disk 53.

A pitching vibration V whose vibration node is a gravity center 51 of the magnetic head causes a contact between a protrusion portion 54 in which the magnetic head surface and its surroundings protrude and the magnetic disk 53, and damages the read and write performance of the magnetic disk device. The magnetic head slider of the embodiment has a function for decreasing amplitude of the pitching vibration generated when the conventional magnetic head slider is used in the magnetic disk device. Although the reason why the amplitude of the pitching vibration can be decreased is not identified, the reason is estimated as follows.

FIG. 8A is a schematic view illustrating an air flow at a portion A of the surface of the magnetic head slider in the magnetic disk device including the magnetic head slider of FIG. 2. FIG. 8B is a schematic cross sectional view of the P-Q cross section in FIG. 8A.

Since the recording medium rotates in the magnetic disk device, air flows from the left side of FIG. 2 to the surface facing the recording medium (air flow 41). In the portion A, the air flow 41 enters from the first step surface 6 and reaches the first ABS 7. Since the first step surface 6 is arranged between the deep groove 5 and the first ABS 7, a stable air flow can be sent to the first ABS 7 while the magnetic disk device is running when the magnetic head slider of the embodiment is used in the magnetic disk device.

Much of the air flowing into the first ABS flows out to the recess surface 8 (air flow 43). However, since the second step surface 10 is arranged, a part of the air flowing into the first ABS 7 flows out to the second step surface 10. As a result, an air flow 42a, 42b (hereinafter, may be referred to as air flow 42) perpendicular to the air flow 41 is generated.

Since the first ABS of the magnetic head slider and the recording surface of the magnetic disk are close to each other, the air flow 42 between the ABS and the recording surface is squeezed out of the surface, and the air flow 42 meets with outflow resistance due to the air viscous effect (so-called squeeze effect). When the magnetic head slider generates the pitching vibration, it is anticipated that attenuation of specific natural vibration of an air film increases by the squeeze effect. When the attenuation of the specific natural vibration increases, the amplitude of the vibration decreases.

When the magnetic head slider of the embodiment is provided in the magnetic disk device, the attenuation of the pitching vibration having a vibration node near the gravity center of the magnetic head slider increases, so that it is considered that the vibration of the magnetic head slider is prevented.

In Japanese Patent Application Publication (KOKAI) No. 2000-268316, the magnetic head slider including at least one groove carved in the ABS is disclosed. However, the disclosed magnetic head slider is provided in order to prevent stiction when the recording medium rotates reversely in a magnetic disk device using a control method of contact start stop (CSS) method. In the disclosed magnetic head slider, the position of the groove carved in the ABS is not particularly limited.

On the other hand, the magnetic head slider of the embodiment is provided mainly in a magnetic disk device using a load/unload method. An object of the magnetic head driver is to provide a magnetic head slider which suppresses unstable vibration mode and enables stable flying even when the flying height is small. It is considered that the suppression of the vibration mode can be realized by decreasing vibration amplitude of the air film on the ABS far from the gravity center of the vibration in the ABS provided in the magnetic head slider. It is because the vibration is more effectively suppressed by controlling the attenuation of the ABS far from the gravity center of the vibration. In the ABS far from the gravity center of the vibration, ABS arranged near the magnetic head is susceptible to the influence of attenuation. The force by the attenuation is represented by the following formula.

F=cv

Here, F is the force by the attenuation [N], c is the attenuation [(N·s)/m], and v is the speed of vibration [m/s]. That is to say, the force by the attenuation is obtained by the product of the attenuation generated in the ABS and the speed of the vibration. The speed of the vibration increases as the ABS generating the attenuation gets farther from the node of the vibration, and the force by the attenuation tends to be great. Therefore, in the ABS provided in the magnetic head slider of the embodiment, the largest attenuation occurs in the first ABS 7 comprised in the upper surface of the second protrusion portion 26 arranged on the first protrusion portion 25 which is arranged to be attached to the magnetic head 22. Therefore, by providing the cutout portion 27 in the second protrusion portion 26, the vibration amplitude of the air film on the first ABS 7 decreases, so that it is considered that the specific vibration mode can be suppressed. It is preferred that the distance between the head surface 9 and the first ABS 7 is smaller than or equal to 5 μm, especially smaller than or equal to 2 μm as seen from the surface of the recording medium of the magnetic head slider. When the distance between the head surface 9 and the first ABS 7 described below exceeds 5 μm, the amplitude of the pitching vibration may not decrease. It is preferred that the second protrusion portion 26 is arranged to be attached to the magnetic head 22 so that the distance between the head surface 9 and the first ABS 7 is within the range described above. It is especially preferred that the second protrusion portion 26 forms a surface level difference from the head module 29. In other words, it is especially preferred that the first ABS 7 and the recess surface 8 forms a surface level difference.

The range from 0.1 to 10 nm in depth of the cutout portion 27 is desirable. In other words, it is preferred that the second step surface 10 is 0.1 to 10 nm lower than the first ABS 7 (distance 61 in FIG. 3). When the level difference between the second step surface 10 and the first ABS 7 is smaller than 0.1 nm, it is difficult to cause the air flow 42 from the first ABS 7 to the second step surface 10. In such a magnetic head slider, the attenuation generated in the first ABS 7 is almost the same as that of a magnetic head slider not including the second step surface. Therefore, the attenuation in the specific natural vibration of the air film on the first ABS does not increase, so that there is a risk that the amplitude of pitching vibration having a vibration node near the gravity center of the magnetic head slider cannot be decreased. On the other hand, although, when the level difference between the second step surface 10 and the ABS 7 exceeds 10 nm, the pitching vibration having a vibration node near the gravity center of the magnetic head slider decreases, a flying force applied to the first ABS 7 is not sufficient and the head flying height decreases when the magnetic head slider is used in the magnetic disk device. Since the head flying height decreases, the magnetic head slider and the recording medium are easy to contact with each other, so that there is a risk that the read and write performance of the magnetic disk device is damaged.

The depth of the cutout portion 27 is not necessary to be uniform in the entire second step surface. There may be a second step surface having a different height, or the height of the second step surface may change continuously.

The range from 0.1 to 0.3 μm in height of the second protrusion portion 26 is desirable. In other words, it is preferred that the first step surface 6 is 0.1 to 0.3 μm lower than the first ABS 7 (distance 62 in FIG. 3). When the first step surface 6 is smaller than 0.1 μm or greater than 0.3 μm, an air flow from the first step surface 6 to the ABS 7 is not sufficient, so that there is a risk that a sufficient head flying height cannot be obtained.

The distance 62 between the first step surface 6 and the ABS 7 is not necessary to be uniform in the entire first step surface. There may be a first step surface having a different height, or the height of the first step surface may change continuously.

Although the distance between the deep groove 5 and the ABS is not limited when the distance is greater than a distance between the first step surface 6 and the first ABS 7, and also greater than a distance between the second step surface 10 and the first ABS 7, the deep groove 5 is normally 1 to 3 μm lower than the first ABS 7. The height of the deep groove 5 is not necessary to be uniform in the entire deep groove 5. There may be a deep groove having a different height, or the height of the deep groove may change continuously.

Next, a manufacturing method of the magnetic head slider of the embodiment will be briefly described. The manufacturing method of the magnetic head slider of the embodiment is not particularly limited, and the magnetic head slider can be manufactured by using an existing thin film manufacturing process including a film formation technique such as sputtering used to manufacture an integrated circuit, a patterning technique using a photolithography method, an etching method, and the like, and a polishing technique such as machine processing, polishing processing, and the like.

The magnetic head slider of the embodiment can be formed by, for example, the method described below. First, the alumina layer 31 is laminated on the slider main body 21 made of AlTiC or the like by the sputtering method or the like. Next, the heater 32, the reproducing head module 34, and the recording head module 36 are sequentially laminated on the alumina layer 31 to form the head module 29. Between the layers of the heater 32, the reproducing head module 34, and the recording head module 36, a non-magnetic layer such as an alumina layer is laminated as needed. Next, an alumina layer is laminated on the head module 29 to form a laminated body.

Next, the laminated body is cut into a predetermined size so that the head surface 9 is exposed, and then, a predetermined position of the cut surface is dug to form the predetermined level difference. Although the method to form the level difference is not limited, for example, a digging operation such as ion milling, argon etching, and the like can be used. To dig a predetermined position, a portion which should not be dug may be preliminarily covered with a protective film before the digging operation. Through the level difference forming process, the magnetic head slider of the embodiment can be obtained.

Although the magnetic head slider of the embodiment comprises the cutout portions each of which is provided to the entire edge portion of the upper surface of the second protrusion portion, the magnetic head slider may comprise a cutout portion provided to at least one edge portion on the upper surface of the second protrusion portion. Here, the edge portion is on one of both sides of the upper surface as seen from the magnetic head.

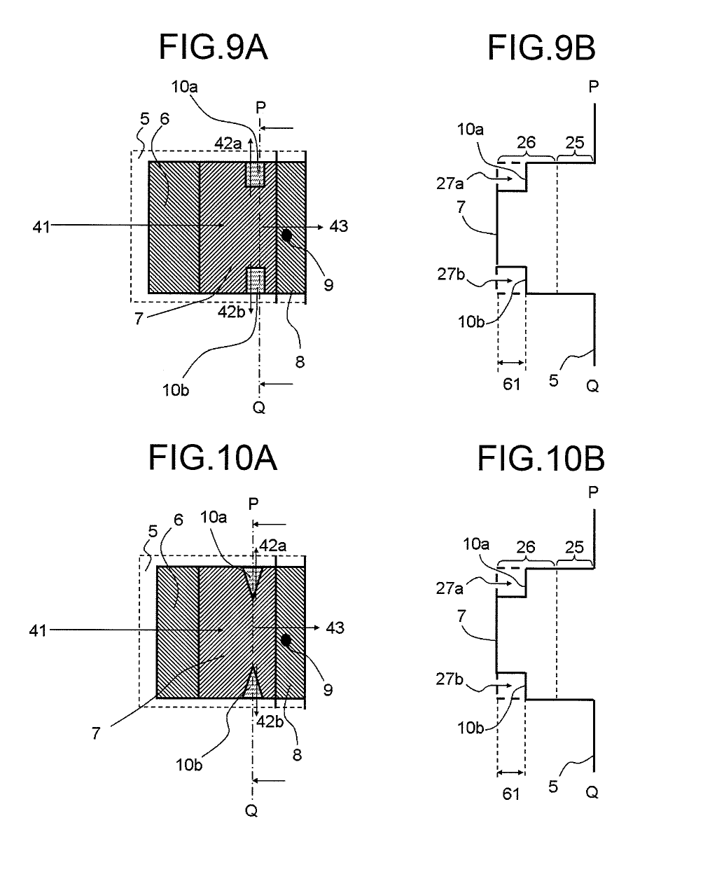

FIGS. 9 to 16 are schematic views illustrating magnetic head sliders according to other embodiments of the invention. FIGS. 9 to 16 are schematic views illustrating only an area around the center island of the surface facing the recording medium in the magnetic disk device when the magnetic head slider is used in the magnetic disk device, and schematic views illustrating shapes of P-Q cross section (or P1-Q1 cross section or P2-Q2 cross section) or R-S cross section of the above schematic views. In the schematic views illustrating shapes of P-Q cross section (or P1-Q1 cross section or P2-Q2 cross section) or R-S cross section of FIGS. 9 to 16, although the dashed lines can be seen when observing the P-Q (or P1-Q1 cross section or P2-Q2 cross section) cross sections or the R-S cross sections, the dashed lines do not exist on the P-Q cross sections (or P1-Q1 cross section or P2-Q2 cross section) or the R-S cross sections.

The embodiments illustrated in FIGS. 9 to 16 are different from the embodiment described by using FIGS. 2 to 8 in the points described below, and the other points are basically the same as those of the embodiment described above, so that redundant description is omitted.

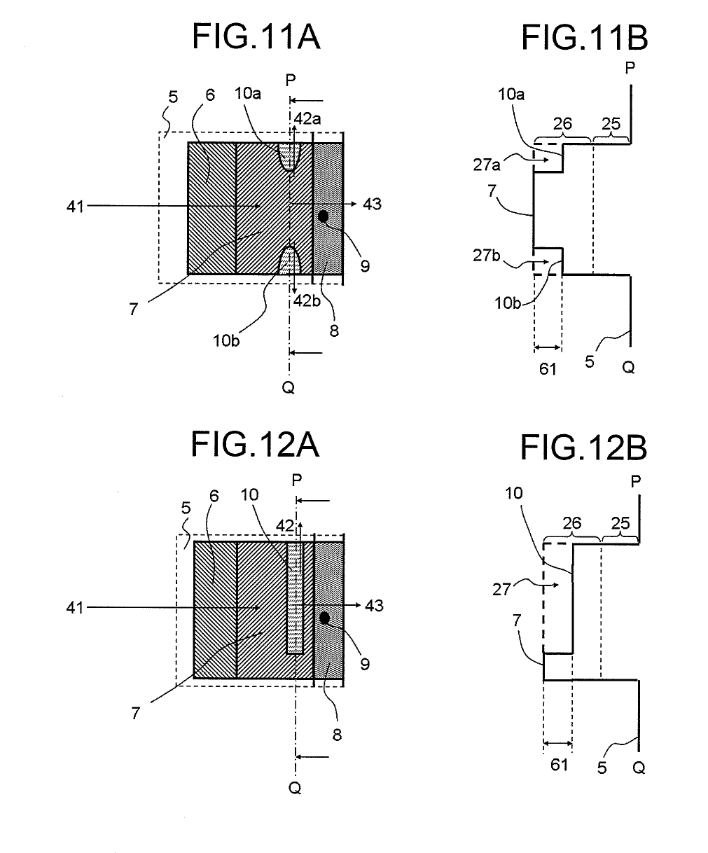

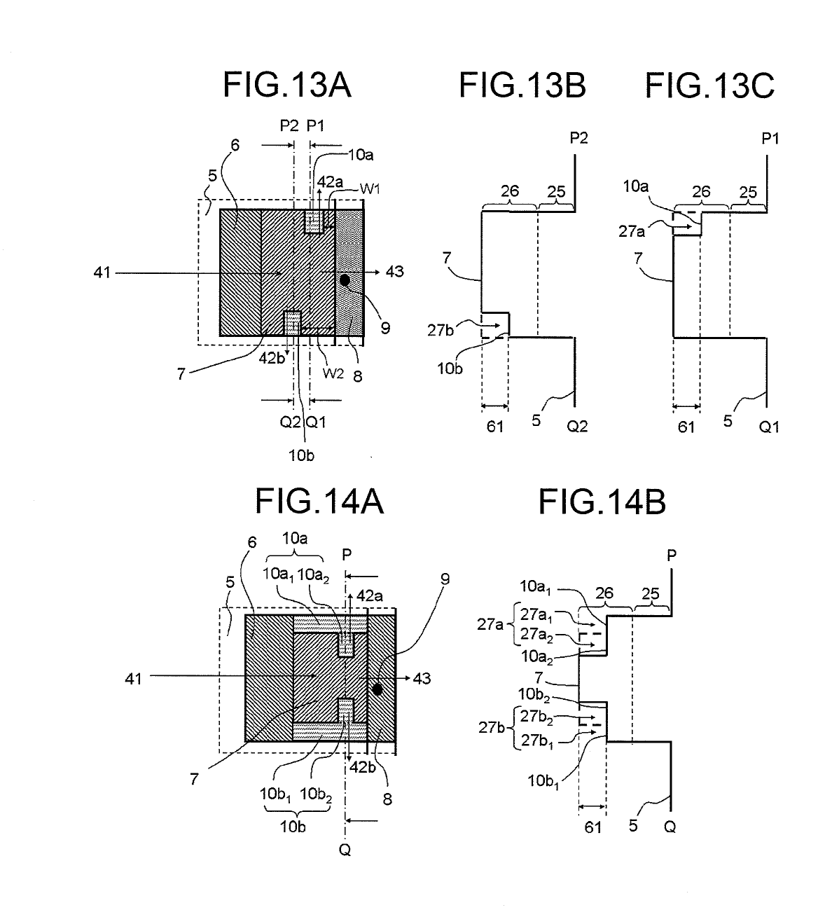

The shape of the cutout portion is not particularly limited by the embodiment. For example, as illustrated in FIGS. 9A and 9B, the bottom portions of the cutout portions 27a, 27b, in other words, the second step surfaces 10a, 10b may have an approximate rectangular shape. Further, as illustrated in FIGS. 10A and 10B, the second step surfaces 10a, 10b may have an approximate triangular shape. Further, as illustrated in FIGS. 11A and 11B, the second step surfaces 10a, 10b may have an approximate semi-elliptical shape. Here, the approximate semi-elliptical shape comprises an approximate semi-circular shape. When the cutout portion 27 is arranged to both sides of the first ABS as seen from the air inflow direction, as illustrated in FIGS. 13A to 13C, a distance W1 between the magnetic head 22 and the cutout portion 27a having its bottom portion on the second step surface 10a may be different from a distance W2 between the magnetic head 22 and the cutout portion 27b having its bottom portion on the second step surface 10b.

It is preferred that the length of the cutout portion 27 in a direction in parallel with the air flow 41 is greater than or equal to 5 μm. When a width of the cutout portion is smaller than 5 μm, during operation the magnetic recording device, an air flow from the first ABS 7 to the cutout portion is insufficient, so that there is a risk that the attenuation generated in the first ABS 7 is about the same as that of a conventional magnetic head slider not including the cutout portion. In this case, the attenuation in the specific natural vibration of the air film does not increase, so that there is a risk that the amplitude of pitching vibration having a vibration node near the gravity center of the magnetic head slider does not decrease. The greater the width of the cutout portion, the more preferable it is because the air flow from the first ABS 7 to the cutout portion increases.

It is preferred that the length of the cutout portion 27 in a direction in parallel with the air flow 42 is greater than or equal to 20 μm. For example, as illustrated in FIGS. 12A and 12B, the length of the cutout portion 27 may be more than a half the length of first ABS 7 (the length in a direction parallel with the air flow 42).

According to another embodiment of the invention, for example, as illustrated in FIGS. 14A and 14B, there is a magnetic head slider including the cutout portions 27a, 27b constituted by combining cutout portions 27a₁, 27b₁ which are provided at both entire side edge portions of the upper surface of the second protrusion portion as seen from the magnetic head and have a bottom portion having an approximate rectangular shape, and cutout portions 27a₂, 27b₂ each of which is partially provided on the first ABS 7 side of the cutout portions 27a₁, 27b₁.

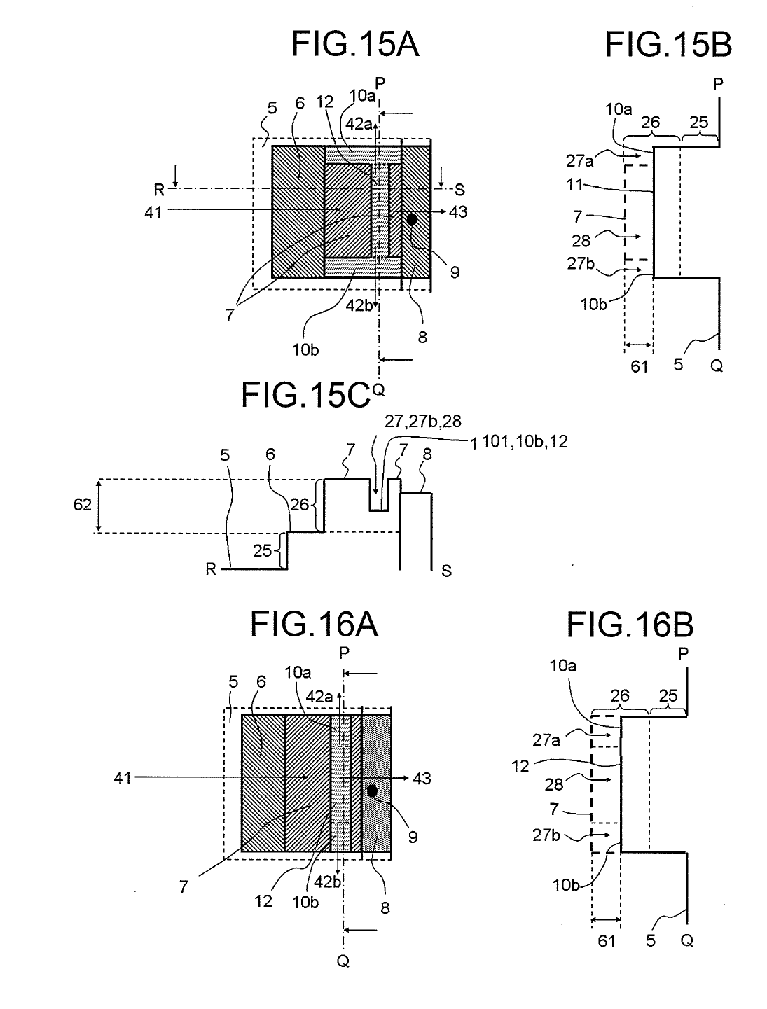

Also, according to still another embodiment of the invention, for example, as illustrated in FIGS. 15A and 15B, there is a magnetic head slider in which the second protrusion portion 26 comprises a slit portion 28 connecting the cutout portions 27a and 27b which are provided at both sides of the upper surface of the second protrusion portion 26 as seen from the magnetic head. This magnetic head slider is preferred because the air flow 42 is generated from the slit portion 28 to the cutout portions 27a, 27b since the slit portion 28 divides the first ABS 7 provided on the upper surface of the second protrusion portion 26 and connects with the second step surfaces 10 provided on both sides of the first ABS 7. Also, according to still another embodiment, as illustrated in FIGS. 16A and 16B, the magnetic head slider may comprise the slit portion 28 connecting the cutout portions 27a and 27b which are provided on both sides as seen from the magnetic head 22.

The range from 28 is 5 to 50 μm in width of the slit portion is desirable. When the width of the slit portion 28 is smaller than 5 μm, an action for flowing air from the first ABS 7 to sideward direction via the slit portion 12 of the slit portion may be insufficient in the magnetic recording apparatus. When the width of the slit portion 28 is greater than 50 μm, although the pitching vibration having a vibration node near the gravity center of the magnetic head slider decreases, the action for flowing air from the first ABS 7 to sideward direction via the slit portion 12 increases too much, and the pressure which the first ABS 7 receives decreases, so that there is a risk that the flying height decreases. When the head flying height decreases, the magnetic head slider and the recording medium are easy to contact with each other, and the read and write performance of the magnetic disk device becomes insufficient. The width of the bottom portion of the slit portion may not be uniform.

The depth of the slit portion 28 is about 0.1 to 10 nm deeper than the first ABS 7 in the same way as the cutout portions 27a, 27b.

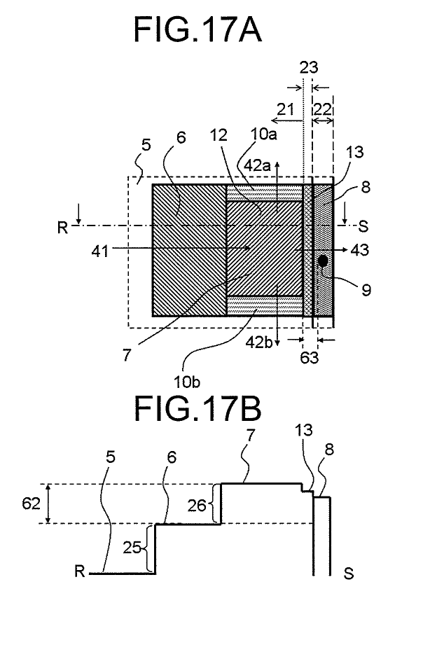

FIGS. 17A and 17B are schematic views illustrating another embodiment of the invention. FIG. 17A is a schematic view illustrating only an area around the center island of illustrating the surface of the magnetic head slider facing the recording medium in the magnetic disk device when the magnetic head slider is used in the magnetic disk device, and FIG. 17B is a schematic view illustrating a shape of R-S cross section of the above schematic view. The embodiment illustrated in FIGS. 17A and 17B is different from the embodiment described by using FIGS. 2 to 8 in the points described below, and the other points are basically the same as those of the embodiment illustrated in FIGS. 2 to 8, so that redundant description is omitted.

In the magnetic head slider of this embodiment, the second protrusion portion does not contact the magnetic head, and the second protrusion portion is arranged so that the first protrusion portion is exposed to backward as seen from the magnetic head. In the magnetic head slider of this embodiment, the recess surface 8 and the first ABS 7 form two steps of surface level differences. The magnetic head slider of this embodiment has a portion 23 including a surface 13 lower than the first ABS 7 between the recess surface 8 and the first ABS 7. The portion 23 is integrated with the slider main body 21. The surface 13 is normally 1 to 3 mm lower than the first ABS. The recess surface 8 and the surface 13 may have the same height. Also, in this embodiment, it is preferred that the gap between the head surface 9 and the ABS 7 surface is smaller than or equal to 5 μm, especially smaller than or equal to 2 μm as seen from the surface of the recording medium of the magnetic head slider because the specific vibration mode can be suppressed. The invention is not limited to the above described embodiments. The above described embodiments are for illustration, and any apparatus having substantially the same configuration as that of the technical ideas described in the claims of the invention and having the same operation effects is comprised within the technical scope of the invention.

A first experimental example of the magnetic head slider will be described with reference to FIGS. 2, 3A, 3B, 3C, 18A, and 19A.

The magnetic head slider of the first experimental example is an illustrative embodiment of the magnetic head slider illustrated in the schematic plan views of FIGS. 2, 3A, 3B, and 3C. The magnetic head slider 1 has a size of 0.7 mm×0.85 mm and is made of AlTiC. As illustrated in FIG. 2, the magnetic head slider of the experimental example 1 comprises the front rail 2, the two side rails 3, and the center island 4.

The third step surface 6′ provided on the front rail 2 is 170 nm lower than the second ABS 7′. The fourth step surfaces 6′ respectively provided on the two side rails is 170 nm lower than the third ABS 7″.

The center island 4 comprises four types of surfaces, which are the first ABS 7, the recess surface 8, the second step surface 10, and the first step surface 6. The second step surface 10 has a rectangular shape. The recess surface, the second step surface 10, and the first step surface 6 are 1.5 nm, 5 nm, and 170 nm lower than the surface of the ABS 7, respectively.

The deep groove 5 is 1.6 μm lower than the first ABS 7, the second ABS 7′, and the third ABS 7″. The distance between the head surface 9 and the first ABS 7 is 2 μm as seen from the surface of the recording medium of the magnetic head slider of the first experimental example.

The flying height of the magnetic head slider in the magnetic disk device including the magnetic head slider of the experimental example 1 is calculated. The diameter of the magnetic disk is 70 mm. The magnetic head slider is arranged at a radius of 27.3 mm. The rotational speed of the magnetic disk is 15,000 rpm.

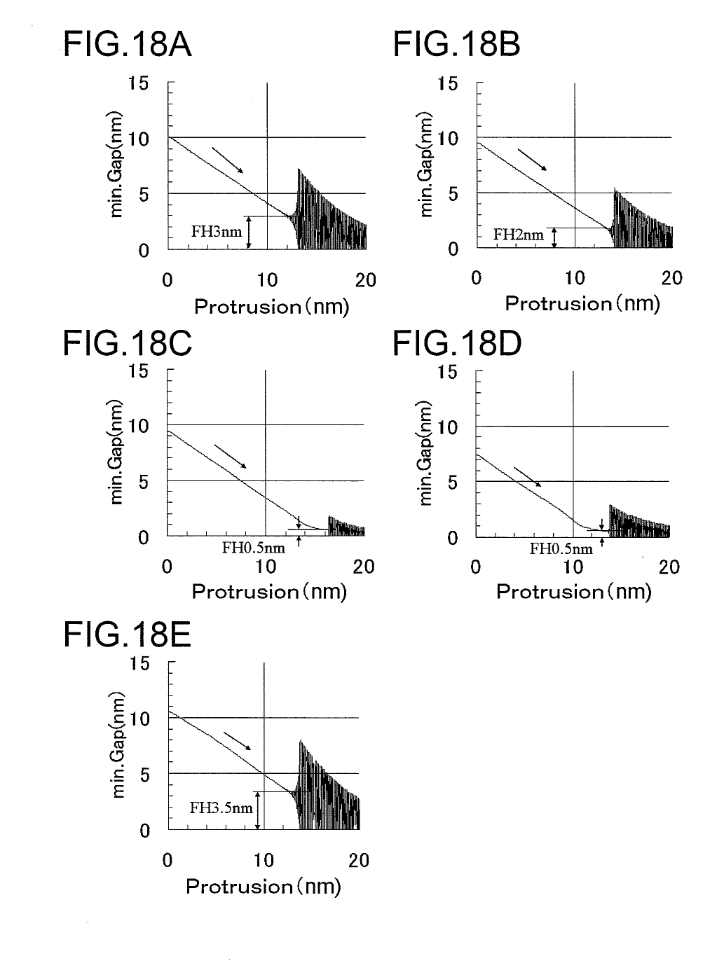

FIGS. 18A to 18D are diagrams illustrating a result of analyzing a relation between a protrusion amount and a head flying height when an area near the magnetic head is gradually protruded in the magnetic disk device including the magnetic head slider of the first to the fourth experimental examples, and FIG. 18E is a diagram illustrating a result of analyzing a relation between a protrusion amount and a head flying height when an area near the magnetic head is gradually protruded in the magnetic disk device including the magnetic head slider of a comparative example. Furthermore, FIGS. 19A to 19C are diagrams illustrating the transfer function of the impulse response of the magnetic head sliders of the first to the third experimental examples, and FIG. 19D is a diagram illustrating the transfer function of the impulse response of the magnetic head sliders of the comparative example. In FIGS. 18A to 18E, a peak near the frequency of 200 kHz is a sympathetic vibration due to the pitching vibration having a vibration node near the gravity center of the magnetic head slider. The transfer function of the impulse response is a ratio (output/input) of pitch angel, which is an output, when a pitch torque of the magnetic head slider is an input.

FIG. 18A is a diagram illustrating a result of analyzing a relation between the protrusion amount and the head flying height when the area near the magnetic head is gradually protruded in the magnetic disk device including the magnetic head slider of the first experimental example.

When decreasing the flying height by heating the magnetic head module and increasing the protrusion amount of the magnetic head, it is found that a large vibration is generated when the head flying height is smaller than or equal to 3 nm. The flying height can be smaller than that of the magnetic head slider of the comparative example described below.

FIG. 19A is a diagram illustrating the transfer function of the impulse response of the magnetic head slider of the first experimental example. The vibration amplitude at the frequency of about 200 kHz of the magnetic head slider of the first experimental example is decreased by 1.5 dB from the vibration amplitude at the same frequency of the magnetic head slider of the comparative example described below. As described above, the magnetic head slider of the experimental example 1 has a structure in which a vibration is difficult to be generated even when the area near the magnetic head is protruded and the flying height is decreased.

The magnetic head slider of the second experimental example 2 will be described with reference to FIGS. 20, 14A, 14B, 18B, and 19B.

The magnetic head slider of the second experimental example is an illustrative embodiment of the magnetic head slider illustrated in the schematic plan views of FIGS. 20, 14A, and 14B. FIG. 20 is a schematic plan view illustrating the surface of the magnetic head slider facing the recording medium in the magnetic disk device when the magnetic head slider of the experimental example 2 is used in the magnetic disk device. FIG. 14A is a partial enlarged view of the portion A of the magnetic head slider in FIG. 20, and FIG. 14B is a cross sectional schematic view illustrating a shape of P-Q cross section in the partial enlarged view. The magnetic head slider of the second experimental example is different from that of the first experimental example in the points described below, and the other points are the same as those of the embodiments described above, so that redundant description is omitted.

The second step surface is constituted by a portion 10a having a rectangular shape and a cutout portion 10b having a square shape. The portion 10a has the same rectangular shape as the second step surface 10 of the first experimental example. The length of the side of the portion 10b is 25 μm.

FIG. 18B is a diagram illustrating a result of analyzing a relation between the protrusion amount and the head flying height when the area near the magnetic head is gradually protruded in the magnetic disk device including the magnetic head slider of the second experimental example.

When decreasing the flying height by heating the magnetic head module and increasing the protrusion amount of the magnetic head, it is found that a large vibration is generated when the head flying height is smaller than or equal to 2 nm. The flying height can be smaller than that of the magnetic head slider of the comparative example described below.

FIG. 19B is a diagram illustrating the transfer function of the impulse response of the magnetic head slider of the second experimental example. The vibration amplitude at the frequency of about 200 kHz of the magnetic head slider of the second experimental example is decreased by 5 dB from the vibration amplitude at the same frequency of the magnetic head slider of the comparative example described below. As described above, the magnetic head slider of the second experimental example has a structure in which a vibration is difficult to be generated even when the area near the magnetic head is protruded and the flying height is decreased.

The magnetic head slider of the experimental example 3 of the invention will be described with reference to FIGS. 21, 15A, 15B, 15C, 18C, and 19C.

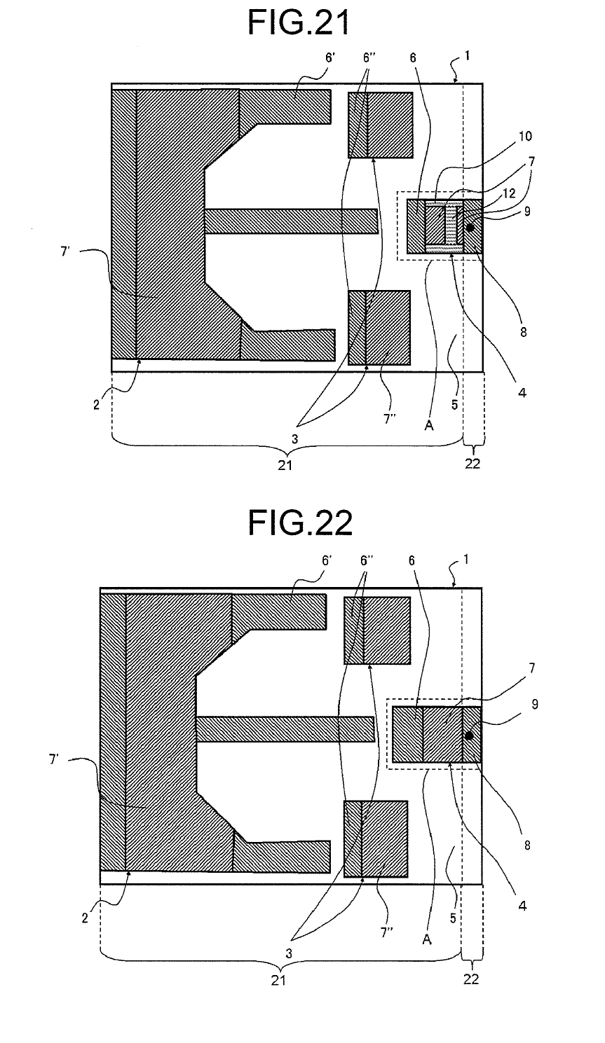

The magnetic head slider of the third experimental example is an illustrative embodiment of the magnetic head slider illustrated in the schematic plan views of FIGS. 21, 15A, 15B, and 15C. FIG. 21 is a schematic plan view illustrating the surface of the magnetic head slider facing the recording medium in the magnetic disk device when the magnetic head slider of the third experimental example is used in the magnetic disk device. FIG. 15A is a partial enlarged view of the portion A of the magnetic head slider in FIG. 21, FIG. 15B is a cross sectional schematic view illustrating a shape of P-Q cross section in the partial enlarged view, and FIG. 15C is a cross sectional schematic view illustrating a shape of R-S cross section in the partial enlarged view. The magnetic head slider of the third experimental example is different from that of the first experimental example in the points described below, and the other points are the same as those of the embodiments described above, so that redundant description is omitted.

The magnetic head slider of the third experimental example comprises the slit portion 28 dividing the surface of the ABS 7 of the magnetic head slider of the first experimental example. The second step surfaces 10a, 10b, and the bottom surface of the slit portion 12 are on the same surface. The width of the slit portion (the length in the direction of air flow 41) is 25 μm.

FIG. 18C is a diagram illustrating a result of analyzing a relation between the protrusion amount and the head flying height when the area near the magnetic head is gradually protruded in the magnetic disk device including the magnetic head slider of the third experimental example.

When decreasing the flying height by heating the heater and increasing the protrusion amount of the magnetic head, it is found that a large vibration is generated when the head flying height is smaller than or equal to 0.5 nm. The flying height can be smaller than that of the magnetic head slider of the comparative example described below.

FIG. 19C is a diagram illustrating the transfer function of the impulse response of the magnetic head slider of the third experimental example. The vibration amplitude at the frequency of about 200 kHz of the magnetic head slider of the third experimental example is decreased by 6.9 dB from the vibration amplitude at the same frequency of the magnetic head slider of the comparative example described below. As described above, the magnetic head slider of the second experimental example has a structure in which a vibration is difficult to be generated even when the area near the magnetic head is protruded and the flying height is decreased.

The magnetic head slider of the fourth experimental example has the same shape as that of the third experimental example, except that the second step surface 10 and the bottom surface 12 of the slit portion are 10 nm lower than the surface of the ABS 7.

FIG. 18D is a diagram illustrating a result of analyzing a relation between the protrusion amount and the head flying height when the area near the magnetic head is gradually protruded in the magnetic disk device including the magnetic head slider of the third experimental example.

When decreasing the flying height by heating the magnetic head module and increasing the protrusion amount of the magnetic head, it is found that a large vibration is generated when the head flying height is smaller than or equal to 0.5 nm. The flying height can be smaller than that of the magnetic head slider of the comparative example described below. When a large vibration is generated, although the vibration amplitude of the magnetic head slider is greater than that of the magnetic head slider of the third experimental example, the vibration amplitude is smaller than that of the magnetic head slider of the first and the second experimental examples.

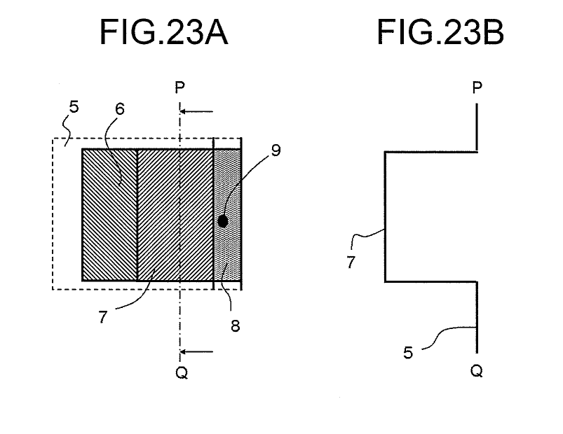

The magnetic head slider of the comparative example will be described with reference to FIGS. 22, 23, 18E, and 19D. FIG. 22 is a schematic plan view illustrating the surface of the magnetic head slider facing the recording medium in the magnetic disk device when the magnetic head slider of the comparative example is used in the magnetic disk device. FIG. 23A is a partial enlarged view of the portion A of the magnetic head slider in FIG. 21, and FIG. 23B is a cross sectional schematic view illustrating a shape of P-Q cross section in the partial enlarged view.

The magnetic head slider of the comparative example 1 has the same shape as that of the experimental example, except that the second step surface 10 of the magnetic head slider of the experimental example 1 is changed to be the same height as the first ABS 7.

FIG. 18E is a diagram illustrating a result of analyzing a relation between the protrusion amount and the head flying height when the area near the magnetic head is gradually protruded in the magnetic disk device including the magnetic head slider of the comparative example. The analyzing method is the same as that of the experimental example.

When decreasing the flying height by heating the magnetic head module and increasing the protrusion amount of the magnetic head, it is found that a large vibration is generated when the head flying height is smaller than or equal to 3.5 nm.

FIG. 19D is a diagram illustrating the transfer function of the impulse response of the magnetic head slider of the comparative example. The vibration amplitude at the frequency of about 200 kHz of the magnetic head slider of the comparative example is −182 dB and larger than the vibration amplitude at the frequency of about 200 kHz of the magnetic head slider of the experimental examples described above.

The magnetic head slider according to any one of the aforementioned embodiments of the invention has a configuration for decreasing amplitude of an unstable vibration which occurs when narrowing the gap between the magnetic head slider and the magnetic disk. Such a magnetic head slider can stably fly even when the head flying height is small, and contributes to realize a high-reliability magnetic disk device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head slider, comprising:
a magnetic head;
a slider main body comprising the magnetic head;
a first protrusion portion on the slider main body and in contact with the magnetic head;
a second protrusion portion on a top surface of the first protrusion portion; and
a cutout portion on an edge portion at a side portion of a top surface of the second protrusion portion.

2. The magnetic head slider of claim 1, wherein the second protrusion portion is configured to face the magnetic medium.

3. The magnetic head slider of claim 2, wherein the cutout portion corresponds to the entire edge portion.

4. The magnetic head slider of claim 2, wherein
the cutout portion comprises a first cutout portion and a second cutout portion,
the edge portion comprises a first edge portion and a second edge portion, the first edge portion being on a first side of the top surface, the second edge portion being on a second side of the top surface opposite to the first side,
the first cutout portion is at the first edge portion, and
the second cutout portion is at the second edge portion.

5. The magnetic head slider of claim 4, wherein the second protrusion portion comprises a slit portion connecting the first cutout portion and the second cutout portion.

6. The magnetic head slider of claim 2, wherein the second protrusion portion is in contact with the magnetic head, and the first protrusion portion is exposed on a first side opposite to a second side where the second protrusion portion is in contact with the magnetic head.

7. The magnetic head slider of claim 2, wherein the magnetic head comprises a magnetic head element configured to protrude when heated.

8. The magnetic head slider of claim 2, wherein a shape of the cutout portion is substantially rectangular, substantially triangular, substantially semi-elliptical, or combination of these shapes.

9. A magnetic disk device comprising a recording medium and a magnetic head slider facing the recording medium, the magnetic disk device comprising:
a magnetic head slider which comprises:
a magnetic head;
a base portion with the magnetic head;
a first protrusion portion on the base portion in contact with the magnetic head;
a second protrusion portion on a top surface of the first protrusion portion facing the recording medium; and
a cutout portion on an edge portion at a side portion of a top surface of the second protrusion portion facing the recording medium.
